(19) United States
(12) Patent Application Publication
(10) Pub. No.: US 2009/0284384 A1
(43) Pub. Date: Nov. 19, 2009

(54) Unobtrusive Power Failure Lighting System

(76) Inventor: Robert A. Barton, Grafton, MA (US)

Correspondence Address: ROBERT A. BARTON, 56 BARBARA JEAN STREET, GRAFTON, MA, 01519, US

(21) Appl. No.: 12/510,154

(22) Filed: Jul. 27, 2009

Related U.S. Application Data
(63) Continuation-in-part of application No. 11/457,867, filed on Jul. 17, 2006, now abandoned.
Application No. 11/457,867 is a continuation-in-part of application No. 10/249,723, filed on May 3, 2003, now Pat. No. 6,805,469.

(51) Int. Cl. G08B 21/00; F21V 15/00

(52) U.S. Cl. 340/635; 362/364

(57) ABSTRACT

An Unobtrusive Power Failure Lighting system is described where a power failure light, is integrated with an electric wiring device and its associated cover plate. An electric wiring device with an electric circuit is described. A cover plate with features for emitting light is also described. The electric wiring device is in communication with the cover plate through a first and second interface. A wireless power system is also described as one implementation of the first and second interface. The cover plate may contain a variety of components allowing the system designer to expand the functionality of the system while keeping manufacturing complexity low. The system is modularly designed to overcome size and space limitations found when combining the multiple safety functions and controls into an electric wiring device that fits into conventional electric work boxes.

### CROSS REFERENCE TO RELATED APPLICATIONS

This application is a continuation-in-part of application Ser. No. 11/457,867 filed Jul., 17, 2006 currently pending, which is a continuation-in-part of application Ser. No. 10/710,189 filed on Jun. 24, 2004 which is a continuation-in-part of application Ser. No. 10/249,723 filed on May 3, 2003, now Pat. No. 6,805,469.

### BACKGROUND OF INVENTION

Emergency lighting devices and other system safety devices are typically installed in such obvious ways that they interfere with visible design and decor of a living space or workspace. Alerting lights or audible alarms for safety conditions frequently require specific installation and wiring. This often affects a person's decision on whether or not to install them. The present invention describes a power failure lighting and alerting device that is modestly inconspicuous by integrating it with commonly used electrical wiring devices such as switches, dimmers, and receptacles. Of course, integration as used herein, refers to the wiring device containing the additional circuitry and components as is described throughout this present application. The resulting enhanced electrical wiring device will likely result in of more installations of power failure lighting and thus safer homes and workplaces.

The present invention relates generally to power failure lighting devices and, more specifically, to a modular power failure lighting system that combines power failure sensing functionality with standard electrical wiring devices. The enhanced electrical wiring device can detect power failure and other safety conditions and in turn, provide a safety signal exterior to the surface of the electrical wiring device. This safety signal is used to turn on a system safety device which is a safety light and/or audible alarm source. The safety signal is provided to an interface integrated into the electrical wiring device enabling the electrical circuitry to communicate with the system safety device. This provides the ability to place the system safety device in direct contact with or external to the electrical wiring device as compared with related prior art inventions.

The present invention is a modular system having an electrical circuit in an electrical wiring device housing enabling it to sense a variety of safety conditions including power failure and other conditions described herein. The electrical wiring device is then able to signal an attached wall cover module that contains power failure safety light source and additional human interface features. This offers improvements over prior art where placing the safety lighting source, audible alarm source, light sensor, and/or user interface control within the electrical wiring device itself is difficult due to the limited space available on the face of existing wiring devices so it is accessible to the user. Newer designs of conventional passive cover plates are emerging as larger structures that may be integral to the electrical wring device mounting mechanism. These larger cover plate sizes offer a stylized appearance and compliment the room décor and appeal to many users upon installation. The present invention allows one or more modular components of the safety lighting device to reside in the cover plate, resulting in reducing overall design complexities and offering other improvements to the manufacturing process over the related concealed safety lighting device of prior art invention. The present invention has other modular functions such as but not limited to the safety lighting source located in the cover plate. The resulting system of an enhanced wiring device and an enhanced cover plate allows more freedom for design as a result of the increased external area and design flexibility.

### DESCRIPTION

In U.S. Pat. No. 6,805,469, the safety lighting source and all user interface control is integrated into the electrical wiring device. The '469 patent describes a concealed safety light that relies on using a conventional cover trim plate to finish off the installation. This reliance allows a user to simply replace a normal switch or receptacle with the concealed safety light and still use the same conventional cover plate. However, the manufacturability is limited due to the small area available in which to put various components of the system and make them visible and useable to a user.

Electric wiring devices are well known and recently are becoming more sophisticated, having more electronics, features and controls available to the user on the exposed face, thus making even the most complex devices recognized and accepted as standard electrical wiring devices. Sometimes the complexity of the controls and user interface intrude on the overall aesthetic appearance of the wiring device and small covers are employed on the wiring device to hide them. The present invention takes advantage of the acceptance of these newer, more sophisticated electrical wiring device styles to advance the practice of concealing a safety light in plain view because people are accustomed to a variety of styles and functionality where switches and receptacles are normally installed. The present invention does this by being similar in design to many electrical wiring devices while presenting functional safety alerting elements that may be noticeable to the observant user while remaining unobtrusive.

The present invention uses the cover plate as one component of the system for concealing a power failure safety light in plain view. It is difficult to incorporate an integrated user control and safety system into the visible portions of the electrical wiring device because placing all of the desired features in a limited area presents unavoidable real estate issues. The present invention mates a cover plate with an electric wiring device that contains a safety condition electrical circuit and an interface to communicate a signal. The electrical wiring device includes but is not limited to one or more of the following: a switch, dimmer, lighting control, receptacle, or a similarly shaped blank body housing, that comprises the electrical circuit that is connected to primary power. The electrical circuit is electrically connected to the primary power wiring and comprises power failure or other alarm condition sensing and generates a signal which is directed to a first interface. The first interface is different than the connection to the primary power. The first interface may be wired, wireless or use optical coupling such as IR transmit/receive. The electrical circuit may also include an ambient light sensing or darkness signal function. The first interface is used to mate with an enhanced cover plate that has a second interface that mates or couples with the first interface.

The cover plate of the present invention comprises one or more of the following components: a user interface for controlling the device, a safety light source, audible alarm source, a light transmission means, a light sensor, an alternate power source, a cover plate circuit, and an interface to allow communication between the modular components in the cover plate and the internal electrical circuit of the electrical wiring device. The light transmission means may be a lens, hole, void, reflector, translucent/transparent cover or light pipe.

A signal that is derived from the primary power source is used for power failure signaling. The power failure sensing function is equally functional in AC or DC primary power systems by making changes to the primary power interface circuitry. This affords power failure protection to standard AC electrical systems as found in most homes, offices and inhabited spaces, as well as automobiles, trailers, boats, mechanical and telecommunication equipment rooms and includes many of today's alternative energy systems that rely on DC battery power.

### DESCRIPTION OF PRIOR ART

Similar prior art power failure safety lighting devices that light up when a power failure occurs, are often embodied in the form of a housing that is used as a wall cover plate that surrounds an existing switch or receptacle electrical wiring device. Their embodiments are designed to mechanically fasten to an already in-place standard switch or receptacle either by direct attached wiring, plug tangs, or wireless means. Prior art devices do not disclose a system that relies upon the electrical wiring device to sense when power has failed or to monitor for other safety condition alert signals. This requires integrating an electrical circuit into the electrical wiring device and sending a safety signal external to the wiring device which no related prior art describes. This new integrated arrangement gives conventional electrical wiring devices the capability of sensing power failure and other certain safety conditions like alarm triggering events where audible alarm alerts or a visible light provides warning and safe passage to those nearby. The modular nature of the Unobtrusive Power Failure Lighting System relies on this integrated sensing capability within the electrical wiring device to enable using the cover plate to achieve improved lighting and alerting solutions. This includes having the cover plate contain alternate power source batteries or having multiple light sources and larger light emitting areas for the safety light to illuminate the surrounding area or a lighting source and an audible alarm source without requiring bulky housings which detract from the overall aesthetic appeal of the solution.

There are electrical wiring devices on the market that contain an audible alert function that emits an alerting noise to specific conditions relating to the function of the electric wiring device. One such product is a surge suppression receptacle model 7280 by Leviton that will emit sound when the protection is off. This audible alarm is not able to respond to externally generated alert signals.

Other than the '469 patent, prior art does not perceive or address the problem of being conspicuous, thus limiting the locations where one would install safety lighting and alerting devices. The system of the present invention includes an electrical wiring device that is substantially the same size and shape as a common electrical wiring device and may also perform the function of the common wall switch, dimmer or receptacle. It installs into the standard electrical workboxes and provides the function of the safety system. It is unobtrusive upon the installation of a cover plate which contains one or more elements of the system, in a reduced form thus overcoming the problem of being conspicuous.

In U.S. Pat. No. 3,739,226 Seiter describes an emergency light for mounting to an electrical wall socket. The apparatus for emergency lighting plugs into a receptacle. It requires an already installed receptacle. It is easily visible and conspicuous in its display and mounting mechanism.

In U.S. Pat. No. 4,514,789 Jester describes an illuminated light switch plate with LED and oscillator circuit to replace a cover plate. It is intended to locate the wall switch in the dark. It is a cover plate that does not teach power failure detection or backup lighting mechanism.

In U.S. Pat. Nos. 5,473,517, 5,713,655, and 6,010,228 Blackman describes a complete solution in a wall cover plate housing having an emergency safety lighting apparatus that replaces a cover plate. It mechanically attaches to the wall switch device using the same screw mounting holes previously used by a standard cover plate. The entire safety light solution is contained in the cover plate. The invention is not integrated with the electrical wiring device that it covers, and merely connects to the available primary electrical wires in the wall box to provide power to the cover plate. The related electrical wiring device is any standard switch or receptacle that has no electrical circuit. The housing containing the safety light is much larger than a standard cover plate leaving it somewhat obtrusive and noticeable when installed. The invention celebrates its appearance with its unavoidable obviousness in a way that is similar to other wall mounted box-like power failure solutions and provides a level of awareness that the premises have some power failure lighting. A wireless interface is also described that does not communicate with an electrical circuit in the electrical wiring device, but merely senses the electromagnetic waves generated by the proximal primary AC power.

In U.S. Pat. Nos. 5,833,350 and 6,000,807 Moreland describes a switch cover plate that houses the apparatus for emergency lighting. It is similar to Blackman in that it is much larger than a standard cover plate and is self contained. It is not an electrical wiring device, but merely an active cover plate.

In U.S. Pat. No. 4,631,649 McCue describes a plug-in emergency light fixture that plugs into a wall receptacle and is semi-permanently mounted by screwing it to the receptacle. None of the components are part of the receptacle and it is not concealed or inconspicuous when installed.

In U.S. Pat. Nos. 6051787, 5,811,729, 5,811,730 and 5,874,693, Rintz describes an electroluminescent switch cover plate having an electroluminescent panel electrically connected to the primary power being switched. It does not teach a power failure lighting device or a distributed system of components to achieve such function. It is not integrated with the wiring device but merely attaches to the primary power directly. In U.S. Pat. No. 7,009,111, Rinz further describes a flexible cover for switches that does have power failure lighting function using the same concept of replacing the cover plate. It utilizes standard switches and receptacles having no integrated electrical circuitry.

In U.S. Pat. Nos. 6,423,900 and 6,087,588, Soules describes an active cover plate for a variety of purposes having rearward facing contacts for connecting with primary power. It relies on a conventional receptacle or switch. It does not describe or teach a power failure lighting device, or a system having components or circuitry integrated with the receptacle.

Prior art generally discloses backup power failure lighting devices that either plug into a power receptacle or replace the cover plate that surrounds conventional switches and receptacles. Prior art does not describe a power failure electrical circuit integrated into electrical wiring devices that presents a signal to the exterior of the electrical wiring device for use with a mating cover plate. The present invention distributes modular elements of the Unobtrusive Power Failure Lighting System into subsystems that together form a system made up of a) an enhanced electrical wiring device that fits into the electrical workbox and b) the cover plate that covers the installed enhanced electrical wiring device and optionally c) a remote central system module. The cover plate may be physically attached to the electrical wiring device housing or the wiring device mounting bracket and employ screws, snap retainers or tabs or other mounting mechanisms to allow one to remove a portion of the cover plate for installation purposes then reassemble for final appearance.

The cover plate has a large surface area that provides for easier placement of one or more system safety devices, user interface mechanisms, batteries and/or light sensor devices and other modules as described herein. The present invention occupies the same physical space and may provide the function of a conventional switch, dimmer, lighting control or receptacle, while simultaneously providing safety functions such as illumination to an area when darkness falls, with or without primary power being available. It also provides an audible alert noise when certain predetermined safety conditions exist, thus rendering the present invention an Unobtrusive Power Failure Lighting System.

The object of the present invention is to conceal the power failure lighting system as much as possible by taking advantage of the ubiquitous nature and visible acceptance of standardized electrical wiring devices and associated cover plates. The present invention fits within the electrical workbox and is includes a cover plate that contains one or more active components. This allows the safety lighting device to be installed in many locations wherever electric wiring devices are found today. The device is installed in the same places as a conventional switch, dimmer or receptacle and covered with the cover plate. The resulting device provides nighttime safety lighting and other various alarm alerting whether primary power is available or not with minimal visible impact on the design or décor of the area where the device is installed.

### SUMMARY OF INVENTION

The present invention is an electric wiring device enhanced with internal circuitry and a first interface that mates with a correspondingly equipped wall cover plate. The wall cover plate is enhanced with a second interface and is in communication with the electrical wiring device's first interface so that it may receive communication signals from the internal circuitry within the enhanced electrical wiring device. The enhanced electrical wiring device may monitor multiple safety conditions such as power failure; various alarm input event signals; darkness using ambient light sensor signal; and a signal from a user pushbutton or switch. The internal circuitry generates a safety signal—that may be electrical, optical or wireless, PLC, IP or Bluetooth, etc. when one of the conditions occur. The safety signal is used either directly or indirectly to energize a system safety device which is a power failure safety lighting source and/or an optional audible alarm source. The system safety device may be directly connected to the safety signal using any suitable second interface connection to the first interface and produce light and/or sound by drawing power directly from the safety signal. When an ambient light sensor detects darkness it can enable the safety signal whether there is primary power or not, thus providing a night lighting or power failure safety lighting function by using an alternate power source. This alternate power source may reside in either of the modules using a signal path between the first and second interface.

The Unobtrusive Power Failure Lighting System optionally provides an audible signal and/or intermittent flashing of light to differentiate types of safety alerts during predetermined alarm conditions. Concealment of the safety system is accomplished by enabling an electric wiring device having an electrical circuit that sends a signal to a first interface when a safety condition exists. The safety condition may be power failure or the receipt of an external signal generated by other safety monitoring systems such as intrusion, fire, water or gas alarms. The Unobtrusive Power Failure Lighting System responds with visible lighting or audible signals or both. The cover plate is mounted over the electric wiring device, communicates with it using the first and second interfaces and contains one or more functional modules as decided by the system designer.

The Unobtrusive Power Failure Lighting System of the present invention is designed to fit in the same places that switches, receptacles, dimmers and other such wiring devices are designed to fit. The primary power interface provides a source to monitor and subsequently derive the signal to adjust power to a safety lighting source and/or audible alarm source which is in communication with said first interface to illuminate the room area through the cover plate for the electrical wiring devices. The Unobtrusive Power Failure Lighting System may be arranged in a variety of ways by placing functional modules in the electrical wiring device and in the cover plate using a wired, optical or wireless interface within the scope of this present invention.

In one of the Unobtrusive Power Failure Lighting System's simplest forms, a safety lighting source or audible alarm source mates directly with the first interface of the electrical wiring device either permanently or removably. The cover plate contains at least one of: a guide, void, reflector or lens to allow the light from a safety lighting source to illuminate the area or to transmit an audible sound external to the cover plate.

In another simple embodiment, the electrical wiring device electrical circuit drives a small IR or visible light LED, or electromagnetic transmission device as the first interface that sends signals toward the cover plate. The cover plate contains a receiver as a second interface that keeps the system safety device off until loss of signal from the first interface. This interface may also be employed to charge a rechargeable alternate power source when primary power is available. This has the advantage of electrically isolating the cover plate from the electric wiring device and to reduce alignment issues when installing the cover plate.

In a more robust embodiment, a second interface that communicates with said first interface is affixed to the cover plate such that a communication path exists between the cover plate and the circuitry that is integrated into the electrical wiring device. When the safety lighting source is affixed to the cover plate and in communication with the second interface, the first and second interfaces are in communication while installed and complete the communication path between the safety lighting source or audible alarm source, in the cover and the signal provided by the circuitry in the electrical wiring device.

In other embodiments, the first and second interfaces also provide a pathway for signal communication between the power sensing or other alarm signal circuit integrated in the electrical wiring device and any one or more of the following: the safety light source an audible alarm source, a user interface, an alternate power source and/or a light sensor. The first and second interfaces may be wireless or direct contact. When designed with a direct contact, one or more of the first and second interface contact lines may be used as a power source supplying power to one or more functions. When a wireless interface is employed, the safety lighting source or audible alarm source is enabled and disabled by the presence or lack thereof of a signal or other circuit contact closure and may rely on an alternate power source to power the wireless interface for the system safety device. Additionally, a wireless power system may be employed as both the power supply and inductive charging system for the alternate power source while primary power is available. Inductive power transfer provides electrical safety by isolating the power in the cover plate from the hazardous higher voltage present in the wiring device. Further, the inductive or wireless power system may also be used to send the power failure state signal or any other information and provide the equivalent of the first and second interface plus power supply.

The Unobtrusive Power Failure Lighting System of the present invention comprises an electrical wiring device installed in its usual manner within a conventional electrical workbox. The electrical wiring device may be controlling an electrical load and therefore may include exemplary devices such as a switch, electric light dimmer, and receptacle including arc sensing or GFCI receptacles. A receptacle may not have anything plugged in and therefore may not be controlling an electric load or the wiring device may be a housing that does not control any load except the load of the electrical wiring device itself. The system's electrical wiring device portion includes an electrical circuit that is connected to a primary power source for detecting the presence or lack of presence of the primary power. An alternate power source and a safety lighting source are connected to the electrical circuit in such a way as to deliver alternate power to the safety lighting source when primary power fails. The alternate power signal may be switched using an electromechanical contact closure such as in a relay or reed switch, or it may be driven using solid state devices, selection being made on cost and space and other issues. The alternate power source may be charged using an inductive charging circuit or wireless power system. An optional light sensing mechanism determines when light should be turned on whether there is primary power available or not. A user control mechanism such as but not limited to a switch, slider or pushbutton may be used to turn on and off the systems alerting device or adjust brightness levels of the safety light and can be a multifunction control or simple on-off or test switch. The user control mechanism may utilize the first and second interface communication path to control the electrical wiring device circuitry behavior including enabling/disabling its functions, or changing the strength of the signals provided to the cover plate.

This combination of shape with said primary electrical wiring interface allows the installation of the power failure lighting and alerting system in the same places as switches, dimmers and power receptacles. It may contain a local alternate power source or remote power source depending on the specific model and safety alerting coverage required. Constructing the power failure lighting and alerting system with a module having the same form factor as conventional electrical wiring devices, regardless of whether they function as the original electric wiring device or not, provides the concealment objective and the unobtrusive appearance characteristics of the present invention.

The term conceal in the context of the present invention does not mean hidden completely from view. The use of the term conceal describes an unobtrusive looking device, substantially similar in shape, size and function of a conventional electrical wiring device such that its presence is easily accepted and unobtrusive as if it were hidden in plain view.

The alternate power to the safety light device may be provided by rechargeable batteries or other electrical power storage devices or a non-rechargeable power source by implementing a simple change to the DC low power circuitry. The battery may be integrated with the electrical wiring device, the cover plate, or remotely located using class 2 or class 3 low voltage wiring. When contained in the cover plate, the alternate power source is safely handled upon removing the cover plate thereby disengaging all contact from said first electrical connector of the electrical wiring device. A battery status indicator may be implemented to alert the user when batteries need replacement or maintenance. An optional light sensor adjusts the intensity of the safety light according to available lighting conditions such as daylight, thereby extending the battery life.

The present invention may deliver illumination using the available primary power and thus provide a nightlight function using the safety lighting source. The nightlight safety lighting may also be controlled by the optional ambient light sensor in the same way as the power failure safety light. This arrangement, along with using a low power safety light source, for example an LED, provides low cost energy saving illumination and little or no heat when compared with standard incandescent nightlights.

Multiple concealed safety light system devices may be installed and controlled by electrically communicating with a remote system module having a detection and signaling mechanism to provide safety lighting economically. The power failure lighting system may protect multiple areas by having a single detection mechanism or a single alternate power source electrically coupled to the light sources concealed in several power failure lighting system devices. The power failure lighting system devices may be a single, fully functional power failure lighting system device and cover plate or a cost reduced system having a centralized system module coupled to a basic safety light system device and cover plate having few local controls and no local battery. The cost of the Unobtrusive Power Failure Lighting System may be reduced when several of the electric wiring devices and cover plates are installed in a living space providing broad coverage in a dwelling and having a remote sensor circuit gather input signals and communicate a signal to the electrical wiring device upon detection of a safety event. The electrical wiring device's electrical circuit may communicate with a remote central system module through low power DC wiring, wireless, IP protocols, or using coded signals such as X10, UPB or other Power Line Communication (PLC), or Power Line Bus (PLB) communication protocols over the primary power wiring. This remote central system module may have an interface to allow fire, smoke, gas, intrusion or any other alarm signals to enable the Unobtrusive Power Failure Lighting System to audibly and/or visually alert the occupants or security personnel of an alarm condition. This allows persons in the affected area, including those with hearing impairment, to be alerted.

The modular versatility of the present invention offers the system designer a variety of ways to overcome space limitations and other design complexity issues by distributing portions of the circuit functions between the electrical wiring device and the cover plate of the present invention. A system designer may choose to implement all of the electrical circuit including the safety lighting source and/or the audible alarm source completely in the electrical wiring device, requiring a light or audio transmission means in the associated cover plate.

It is well known that cover plates are available in a variety of shapes and sizes and may even be integral to the electrical wiring device's mounting mechanism. The present invention takes advantage of this variety to camouflage the installation thus concealing in plain view the entire power failure lighting and alerting system. Electrical wiring devices with cover plates are found in many locations and are in plain view, serving the purposes for which they are designed thus providing an unremarkable and concealed appearance for a power failure lighting and alerting device. While mainly applicable to utility supplied AC power to inhabited places, the present invention may be implemented into wiring devices for enclosed spaces where it is necessary to have some light for safety reasons such as automobiles, planes, boats, trains and trucks. The primary power may be Direct Current (DC) and the cover plates in these spaces may be convenience light switch panels, map light switch panels, tilt switch enabled light enclosures or other specially designed housings and control panels in which electrical wiring devices are installed.

In summary, the Unobtrusive Power Failure Lighting System of the present invention provides its users increased safety and security by providing illumination in the form of night lighting, power failure lighting, and alarm condition audio or visual warning indication and is concealed in an electrical wiring device in such a way that is acceptable to install without detracting from local surrounding area design and décor.

A primary object of the present invention is to provide a system of components that when installed, form a power failure lighting and alerting signaling solution that utilizes the space normally occupied by an electrical wiring device and its cover plate to improve safety.

Another object of the present invention is to enable common electric wiring devices to monitor and detect predetermined safety events and to supply a signal to indicate that said events occurred.

Another object of the present invention is to enable electric wiring device cover plates to be the source of a safety alerting signal without detracting from its original purpose, function and general design, thus helping to conceal or camouflage the power failure lighting and alerting features.

An additional object of the present invention is to improve the manufacturability and features of the concealed safety lighting device of U.S. Pat. No. 6,805,469 by utilizing the space and area afforded by the cover plate to improve placement options for the present safety lighting and alerting system's components. This is accomplished by moving one or more functions into the cover plate thereby reducing the size requirements, shape and form of the electrical wiring device and reducing the complexity of placing the optional user interface components such that the user may conveniently access the features of the present invention.

A further object of the present invention is to provide a power failure lighting system that is similar to and appears to be a commonly installed electrical wiring device thus having little or no visible impact on interior space designs, effectively concealing it in plain view, and thus overcoming the shortcomings of prior art devices.

Another object of the present invention is to provide an alert using one or more system safety devices that provide light or audible noise for the purpose of making users aware of the existing safety condition.

A further object of the present invention is to provide audible and/or visual warning to alert users that an alarm condition exists from smoke, fire, gas, water, intrusion, or other alarm events and systems thereby improving safety and security in many places.

Another object of the present invention is to provide a system for providing power failure lighting and alerting that is able to detect the occurrence of a power failure.

Another object of the present invention is to provide a system for providing power failure lighting and alerting in an inconspicuous manner to multiple room areas during power failures and other safety conditions by installing it in many locations throughout a house, building, vehicle or other space equipped with primary power.

A further object of the present invention is to provide a concealed power failure lighting device that includes a light detection mechanism for reducing the intensity of the emergency light when other light sources such as daylight are available to extend the life of the alternate power source during extended power outages or determining when nightlight operation should begin, or whether audio or visual alerting should be used.

A still further object of the present invention is to provide a concealed power failure lighting and alerting device that includes a user control for selectively turning the safety light off during a power outage to conserve battery life if lighting is not desired or needed in that area for a specific period of time.

Another object of the present invention is to provide a concealed power failure lighting and alerting device with a safety lighting source that can be adjusted to different levels of brightness by signal command or at the user's discretion.

Another object of the present invention is to provide a concealed power failure lighting and alerting device that is activated and available for use with no specific action to be taken by the user.

A still further objective of the present invention is to provide safety lighting in the darkness regardless of the state and availability of primary power.

Another object of the present invention is to provide nighttime lighting when primary power is available for use as a nightlight in a concealed, unobtrusive manner allowing for a more child safe, non-removable night lighting device to take the place of the plug-in lighting devices found today.

A still further object of the present invention is to provide a concealed power failure lighting and alerting device that is economical in cost to manufacture resulting in end user costs that imply affordability allowing for immediate commercial use.

An additional object of the present invention is to be easy to install with no additional knowledge necessary than that needed to install or replace conventional receptacles or switch devices.

Numerous devices for providing alternate safety lighting have been provided in the prior art. While these units may be suitable for the particular purpose to which they address, they would not be as suitable for the purposes of the present invention as heretofore described.

Additional objects of the present invention will appear as the description proceeds. An Unobtrusive Power Failure Lighting System is disclosed by the present invention. The Unobtrusive Power Failure Lighting System includes an electrical wiring device form factor, a cover plate, a first interface, a local or remote power source, a local or remote safety condition electrical circuit connected to the primary power source for detecting a voltage failure of said primary power source, an alternate power source, one or more safety light sources connected between the detection circuit and the alternate power source and a means to transmit the light from the light source into the room area, an optional audible alarm source to audibly alert users to an existing safety condition.

To the accomplishment of the above and related objects, this invention may be embodied in the forms illustrated in the accompanying drawings or other forms described in the present application, attention being called to the fact, however, that the drawings are illustrative only, and that changes may be made in the specific construction illustrated and described, within the scope of the appended claims.

### BRIEF DESCRIPTION OF DRAWINGS

Various other objects, features and attendant advantages of the present invention will become more fully appreciated as the same becomes better understood when considered in conjunction with the accompanying drawings, in which like reference characters designate the same or similar parts throughout the several views and exemplary embodiments. Many variations of the shape and function of the Unobtrusive Power Failure Lighting System are possible. For the purpose of demonstrating the versatility of the present invention, the figures and drawings depict several different examples of the variations. Other designs are possible within the scope of the present invention.

FIG. 1A shows the main components of one embodiment of the Unobtrusive Power Failure Lighting System, specifically the electrical wiring device in the form of a switch having a first interface. FIG. 1B is a view of the cover plate and its possible components that form the Unobtrusive Power Failure Lighting System.

FIG. 2A shows a second embodiment of the main components of the Unobtrusive Power Failure Lighting System, specifically the electrical wiring device in the form of a classic receptacle having a first interface. FIG. 2B is a view of the cover plate and its modular components that form the Unobtrusive Power Failure Lighting System.

FIG. 3A is a front view of a third embodiment showing a decorative style switch and oversized cover plate having a lens for the safety light transmission and a user interface control. FIG. 3B is a rear view of the same cover plate showing a light transmission means, second interface and safety lighting source and circuit board. FIG. 3C is an exploded view of the system components in the form of a decorative style electrical wiring device and its associated cover plate.

FIGS. 4A and 4B show the power failure lighting system components in the form of a decorative receptacle. FIG. 4C shows a simple embodiment having at least a light guide in the cover plate through which the power failure lighting source can emit light into a room area.

FIGS. 5A, through 5G are reference design schematic diagrams of circuits for the Unobtrusive Power Failure Lighting System of the present invention. Each figure demonstrates various functional components of the system and how they may be distributed between the electrical wiring device and the cover plate. Various other combinations are possible within the scope of the present invention.

FIG. 6 is a functional block diagram of the Unobtrusive Power Failure Lighting System of the present invention.

FIG. 7 shows one example of a remote central system module having multiple Unobtrusive Power Failure Lighting System devices. The devices communicate with the remote central system module via power line communication signals and have an optional low voltage wiring interface for powering system safety devices. System safety devices may be a safety lighting source used to provide steady or intermittent light and/or an audible alarm source to alert users of the safety condition. Power failures require power failure lighting in the form of steady illumination, while other safety condition alarms require light and/or noise to warn users of the safety condition.

### DESCRIPTION OF THE REFERENCED NUMERALS

Turning now descriptively to the drawings, in which similar reference characters denote similar elements throughout the several views, the figures illustrate the concealed power failure lighting device in different embodiments of the present invention. With regard to the reference numerals used, the following numbering is used throughout the various drawing figures.
10. Safety lighting source.
12. System safety device.
15. Audible alarm source.
20. Switch device housing.
25. Receptacle device housing.
30. Light transmission means.
35. Audio transmission means.
40. Ambient light sensor.
45. Clear or translucent area.
50. User interface control.
55. Electrical circuit.
60. Alternate power source.
70. First interface.
80. Second interface.
90. Circuit board.
100. Switch Cover Plate.
110. Receptacle Cover Plate.
120. Primary power interface
130. Circuit board retainer
140. Switch mounting bracket.
145. Receptacle mounting bracket.
146. Mounting holes.
147. Screw.
150. Electrical utility work box.
160. Lens.
165. Rear cover.
170. Snap retainer.
180. Electric wiring device.
400. Low battery warning indicator.
410. Powerline communications interface.
420. Signal decode logic.
430. Voltage supply bus.
440. First diode.
450. Wireless transmitter module.
460. Wireless receiver module.
480. Wireless antenna.
485. Wireless Power Transmission means
486. Wireless Power Receiver means
490. Optical wireless emitter.
495. Optical wireless receiver.
700. Remote central system module.
710. Power Line Control signal.
720. Low voltage wiring.
740. Remote light sensor.
750. Primary power supply cord.
760. Remote electrical circuit.
770. Remote battery.
775. Remote test button.
780. Alarm input event interface connector.
790. Safety lighting and alerting device.

### DETAILED DESCRIPTION

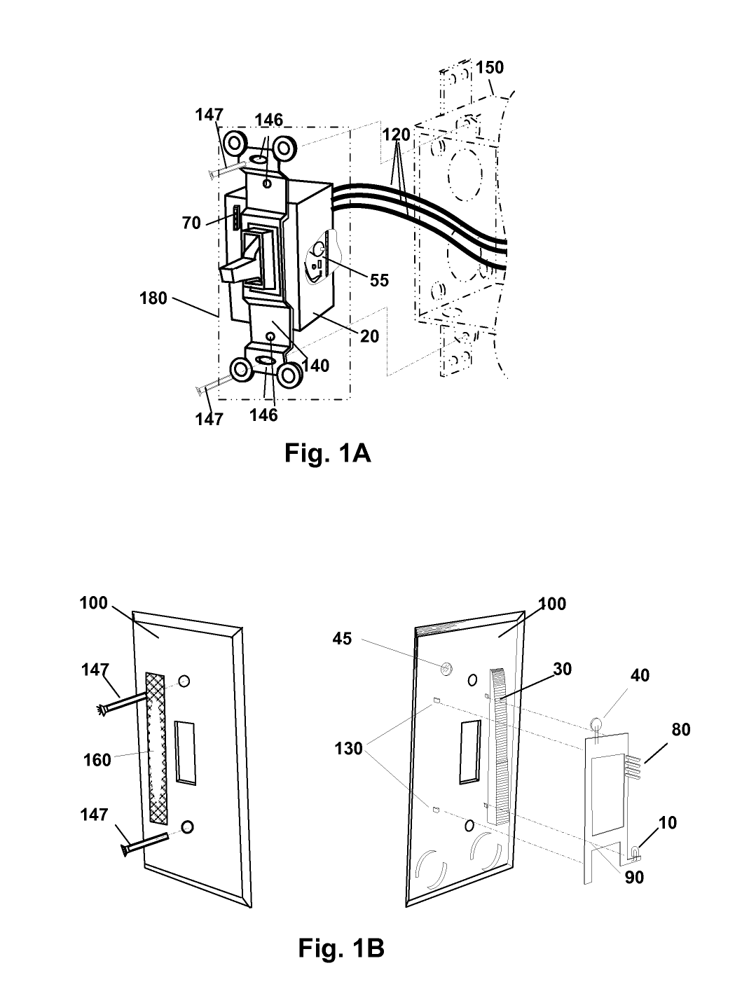

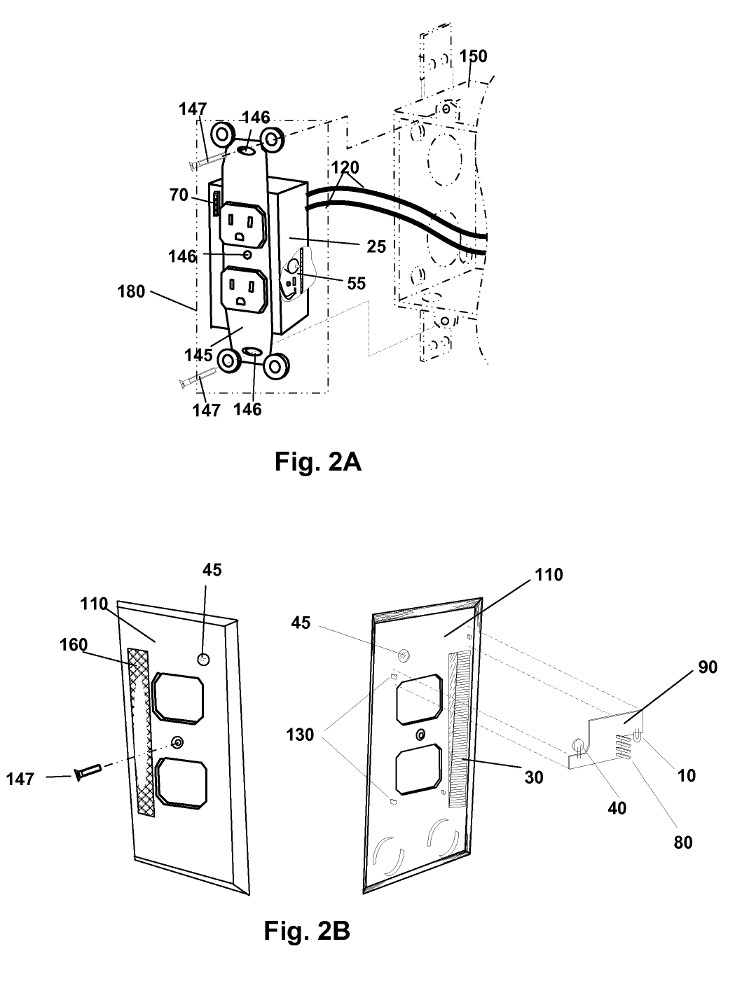

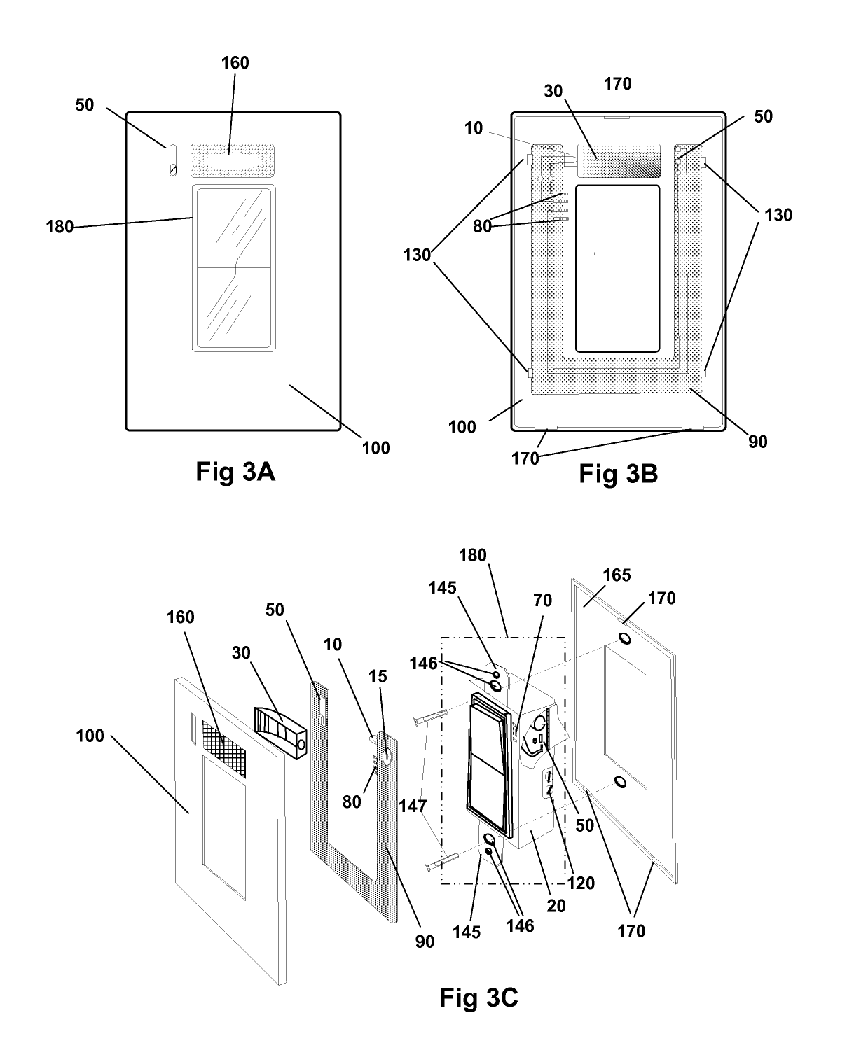

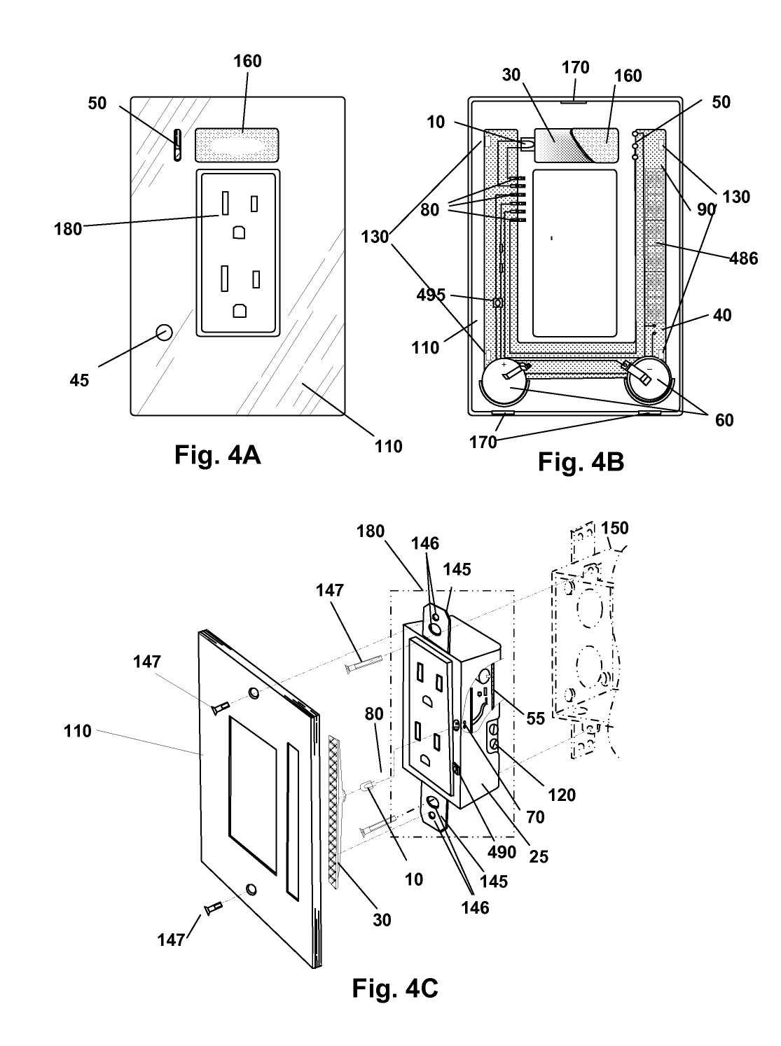

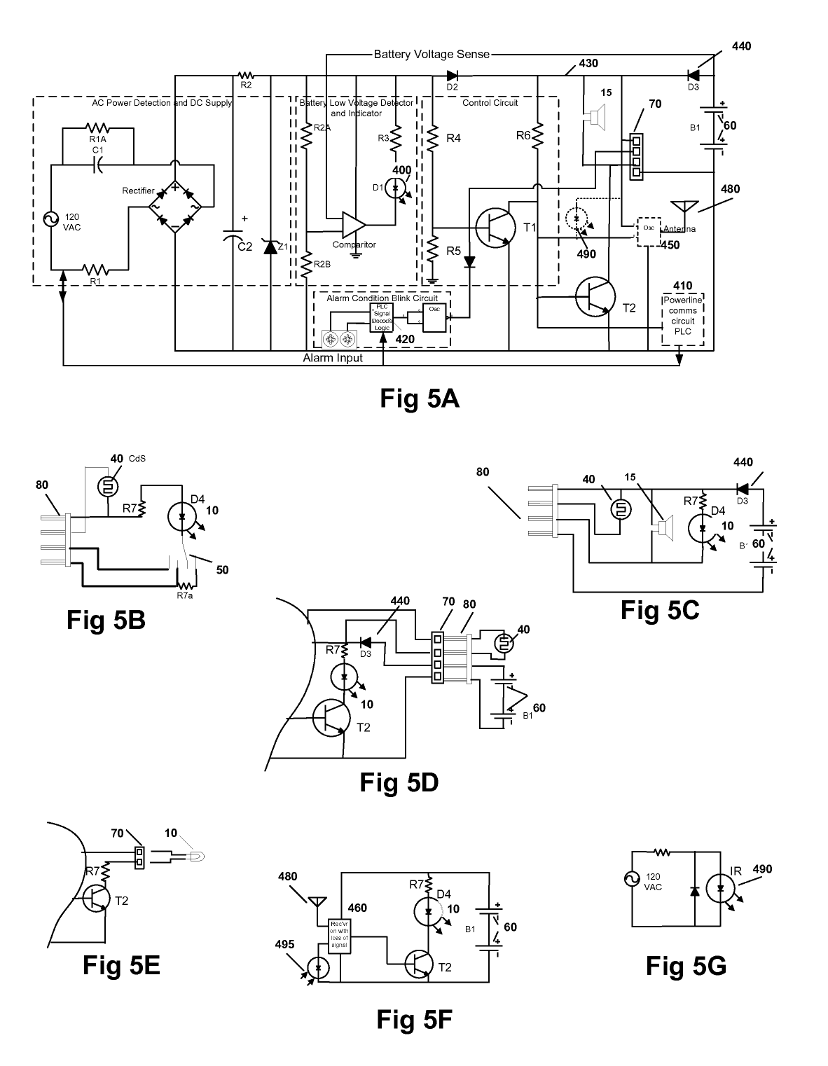

Turning now descriptively to the drawings, in which similar reference characters denote similar elements throughout the several views, FIGS. 1A through 4C illustrate examples of different embodiments of the Unobtrusive Power Failure Lighting System of the present invention. FIGS. 1A through 2C illustrate classic styles of switches and receptacles and cover plates. Other implementations for the concealed power failure lighting device using decorative or Decora wiring devices are shown in FIGS. 3A through 4C depicting how substantially similar their structure and function are in allowing any style wiring device to be used to conceal a power failure lighting and alerting system of the present invention. FIGS. 5A thru 5G show examples of circuit designs that can be used to implement the system, particular attention being paid to FIGS. 5B through 5F which demonstrate how various functions of the system can be mounted separate from the electrical wiring device. FIG. 5G shows a simple electrical circuit for the electric wiring device.

FIGS. 1A and 1B show one embodiment of an Unobtrusive Power Failure Lighting System. FIG. 1B shows a switch cover plate 100 having a lens 160 as viewed from the front of the switch cover plate 100. The safety lighting source 10 is mounted on circuit board 90 in such a way as to allow the light to diffuse through light transmission means 30 such as a reflector or light pipe which allows light to exit through lens 160 in the front of switch cover plate 100. Ambient light sensor 40 is mounted on circuit board 90 in such a way as to sense ambient light levels through clear or translucent area 45 causing adjustment of the level of power to the safety lighting source 10. Circuit board 90 is mounted to the rear facing side of switch cover plate 100 utilizing circuit board retainers 130. FIG. 1A shows the electric wiring device 180. Switch device housing 20 is attached to switch mounting bracket 140 having all the standard structure to allow installation into a conventional electrical utility work box 150 and cover with a cover plate using mounting holes 146. Switch device housing 20 contains the electrical circuit 55 in communication with a first interface 70 to electrically communicate with the second interface 80 on circuit board 90. The system otherwise appears substantially the same as a conventional switch device when switch cover plate 100 is attached, thereby covering the entire device installation. The primary voltage interface 120, electrically connects the Unobtrusive Power Failure Lighting System to the primary power source.

FIGS. 2A and 2B show another embodiment of an Unobtrusive Power Failure Lighting System. FIG. 2A shows the electric wiring device 180 that is a receptacle device housing 25 that mounts into an electrical utility work box 150 using screws 147 through mounting holes 146. The receptacle device housing 25 contains the electrical circuit 55 in communication with first interface 70 and a primary voltage interface 120. FIG. 2B shows a receptacle cover plate 110, having a lens 160 as viewed from the front of the receptacle cover plate 100 FIG. 2B also shows the rear facing side of the receptacle cover plate 110. Circuit board 90 is mounted to the receptacle cover plate 110 using circuit board retainer 130. Safety lighting source 10 emits light into light transmission means 30 where it is conveyed to the front of receptacle cover plate 110 and through lens 160. The second interface 80 mates with first interface 70 when receptacle cover plate 110 is mounted to the electrical wiring device 180.

FIG. 3A shows a front view of yet another embodiment of the Unobtrusive Power Failure Lighting System having a decorator style switch. The electric wiring device 180 is covered by switch cover plate 100 having lens 160 and a user interface control 50.

FIG. 3B shows the rear of switch cover plate 100 having circuit board 90 mounted using several of circuit board retainer 130. The user interface control 50 is mounted through circuit board 90. Safety lighting source 10 is mounted in such a way that the light emitted is directed through light transmission means 30 which guides the light through switch cover plate 100 through lens 160. Snap retainer 170 is use to affix switch cover plate 100 to an optional rear cover 165.

FIG. 3C shows an exploded view of the Unobtrusive Power Failure Lighting System having a decorator style switch. In this example, safety lighting source 10 is mounted on circuit board 90 and uses light transmission means 30 to convey the light through lens 160. The electric wiring device 180 is mounted to an electric utility work box using screws 147 through mounting holes 146 and captures a rear cover plate 165. Primary voltage enters the device through primary voltage interface 120 which are screws that are electrically connected to primary power when installed. Switch cover plate 100 is mounted over the electric wiring device 180 causing first interface 70 to mate with second interface 80 completing the Unobtrusive Power Failure Lighting System circuitry. The switch cover plate 100 is held in place by engaging snap retainers 170 on rear cover 165. When safety lighting source 10 is energized, the light exits the front of the assembly through lens 160. When audible alarm source 15 is installed on circuit board 90, an audible alert is generated when energized.

FIG. 4A shows a front view of another embodiment of the Unobtrusive Power Failure Lighting System having a decorator style receptacle. The electric wiring device 180 is covered by receptacle cover plate 110 having lens 160 and a user interface control 50. An optional clear or translucent area 45 to allow ambient light to pass through the receptacle cover plate 110 is shown.

FIG. 4B shows the rear of receptacle cover plate 110 having circuit board 90 mounted using several of circuit board retainer 130. The user interface control 50 is mounted through circuit board 90. Safety lighting source 10 is mounted in such a way that the light emitted is directed through light transmission means 30 which guides the light through receptacle cover plate 110 through lens 160. Ambient light sensor 40 is mounted on circuit board 90 which receives light through the clear or translucent area 45. Snap retainer 170 is use to attach receptacle cover plate 110 in place. At the system designers discretion, optical wireless emitter 490 and optical wireless receiver 495 or wireless receiver means 486 may be used as an alternative interface. Of course, wireless power transmission means 486 may be employed to caryy the safety signal and charge alternate power source 60.

FIG. 4C shows an exploded view of a similar Unobtrusive Power Failure Lighting System having a decorator style receptacle. In this example, safety lighting source 10 is mounted directly to first interface 70 and uses light transmission means 30 in receptacle cover plate 110 to convey the light through the receptacle cover plate 110. The electric wiring device 180 is mounted to an electric utility work box 150 using screws 147 through mounting holes 146 in receptacle mounting bracket 145. Primary voltage enters the device through primary voltage interface 120 which are screws that are electrically connected to primary power when installed. Electrical circuit 55 monitors the primary voltage and generates a signal on the first interface 70 when a power failure or other safety alert condition is present. Receptacle cover plate 110 is mounted over the electric wiring device 180 and held in place by retaining screws 147. When safety lighting source 10 is energized, the light exits the front of the assembly through light transmission means 30.

Electrical circuit Operation Description. The following describes one design of how the safety condition sensing reference design circuitry operates to provide necessary function as described in the present invention.

Referring to FIG. 5A, the Primary Power Detection and DC Supply circuit represents a common transformer-less low power DC power supply design and may be implemented locally or remotely in other power supply designs without impacting the scope of this present invention.

Battery Low Voltage Detector: Many devices are currently available to detect a voltage threshold and activate an indicator. This is one design to demonstrate how the present invention is able to incorporate the function. This circuit is optional and may be omitted without impacting the scope of the present invention.

FIGS. 5A through 5G demonstrate examples of how the components of the power failure lighting and alerting system may be distributed between the electrical wiring device and its associated cover plate in various combinations without impacting the scope of the present invention. FIGS. 5A and 5C demonstrate how the audible alarm source 15 may be implemented and have several components mounted in the cover plate. FIG. 5B shows ambient light sensor 40, alternate lighting source 10, and user interface control 50 located in the cover plate connected to second interface 80. FIG. 5C shows ambient light sensor 40, audible alarm source 15, alternate lighting source 10, first diode 440, and alternate power source 60 connected to second interface 80 affixed to the cover plate. FIG. 5D shows the alternate power source 60 and ambient light sensor 40 located in the cover plate connected to second interface 80. FIG. 5E shows safety lighting source 10 connected directly to first interface 70 allowing a system designer to implement a simple embodiment as previously described. FIG. 5F shows a wireless receiver module 460 having a wireless antenna 480 or optical wireless receiver 495, capable of turning on a safety lighting source 10 upon loss of wireless signal. FIG. 5G shows a very simple power electrical circuit driving a signal using an optical wireless emitter 490.

Control Circuit: In this example power-signal circuit, transistor T1 is held in the on state through resistor divider network R4 and R5 as long as primary power is available. The output of T1 will keep the audible alarm source 15 or safety lighting source 10 in the off state by turning off transistor T2. The output of T1 may also be used to enable a wireless transmitter module 450 or optical wireless emitter 490. Current flow while primary power is applied is supplied through D2 through R6, through T1. In this reference example, ambient light sensor 40 may have no function when primary power is on since R4 will hold T1 on, T2 off and audible alarm source 15 or safety lighting source 10 off. The ambient light sensor 40 may function when primary power is on by eliminating or reducing the value of R4.

When primary power is unavailable, transistor T1 will control the brightness of the safety lighting source 10 through the ambient light sensor 40 which will develop a lower resistance as more light is detected. This raises the bias voltage on the base of transistor T1 with respect to the amount of ambient light detected, thereby turning off audible alarm source 15 or safety lighting source 10 and reducing current drain on the alternate power source battery 60 to extend its useable life. Transistor T1 will also respond to a detected alarm condition signal and turn T2 on with a predetermined steady or flashing signal resulting in light or audible noise being emitted regardless of the state of the ambient light sensor 40.

When primary power is available, transistor T1 can optionally be used to control the brightness of the safety lighting source 10, through the ambient light sensor 40 and to provide a night light function by changing the value of the bias voltage at the base of T1 to a value that allows transistor T1 to turn off when a predetermined light level is reached. In this case, audible alarm source 15 is not installed.

Power Failure Operation: The power failure detection circuit is based on having a primary power source, an alternate power source 60 and at least one diodal element passing current in only one direction. The primary power source normally provides power to a common voltage supply bus 430.

This bus is electrically connected to a diodal element, in this reference example, first diode 440, passing current in one direction. First diode 440 is electrically connected to the alternate power source with an associated polarity that will allow the alternate power source 60 to supply power to the voltage supply bus 430. First diode 440 is reversed biased while primary power is available to the voltage supply bus causing no electrical discharge of the alternate power supply. When primary power is no longer available, the first diode 440 becomes forward biased causing the alternate power source to discharge to the load that is electrically connected to the voltage supply bus 430. A second diodal element may be electrically connected to the voltage supply bus 430 in opposite polarity to the first diode 440 as a means of preventing current flow to portions of the circuitry when supplied by alternate power source 60. This circuit arrangement allows for automatic failover of supplying power to the voltage supply bus 430. The load that is electrically connected to the voltage supply bus 430 continues to be powered when primary power has failed. The load comprises elements used to derive a power failure signal that is supplied to various other features of the circuit.

Control Circuit: The safety lighting source 10, in this reference example a light emitting diode, will remain off while transistor T2 is off. Resistor R7 limits the amount of current through the LEDs and is chosen to optimize light output and battery life. The optional on-off-test switch 50 will allow the audible alarm source 15 or safety lighting source 10 to be activated. The low voltage detector circuit is designed into the circuit in such a way as to trigger the low battery warning indicator 400 when primary power is present and the battery voltage falls below a certain voltage determined by the resistor divider R2A and R2B.

Alarm Condition Blink Circuit: Receiving a coded signal or closing the circuit at the Alarm Input terminals causes the signal decode logic 420 to enable the oscillator circuit to intermittently pull down the base of T1 regardless of the state of the ambient light sensor 40 or the state of primary power. This signal allows transistor T2 to turn current on and off through the audible alarm source 15 or safety lighting source 10 causing said safety lighting source 10 to blink or audible alarm source 15 to beep in response to the alarm condition. When activated, the Powerline communications interface 410 sends a coded signal out over the primary power lines through primary power supply that can be received by any concealed safety lighting and alerting device equipped with optional alarm condition blink circuitry containing signal decode logic 420.

Wireless Power Transmission Circuit: Due to the close proximity of the cover plate to the electric wiring device, an alternating current operating at a specific frequency that is directed through a resonant inductive loop will couple with and transfer power to a second tuned resonant inductive loop. The transmitted power may be used to charge the alternate power source 60. The transmission of power from wireless power transmission means 485 to the closely coupled wireless transmission receiver 486 and associated rectifier may also indicate that power is normal and used as a power failure safety signal. This safety signal is used to determine if the safety light source needs to be energized.

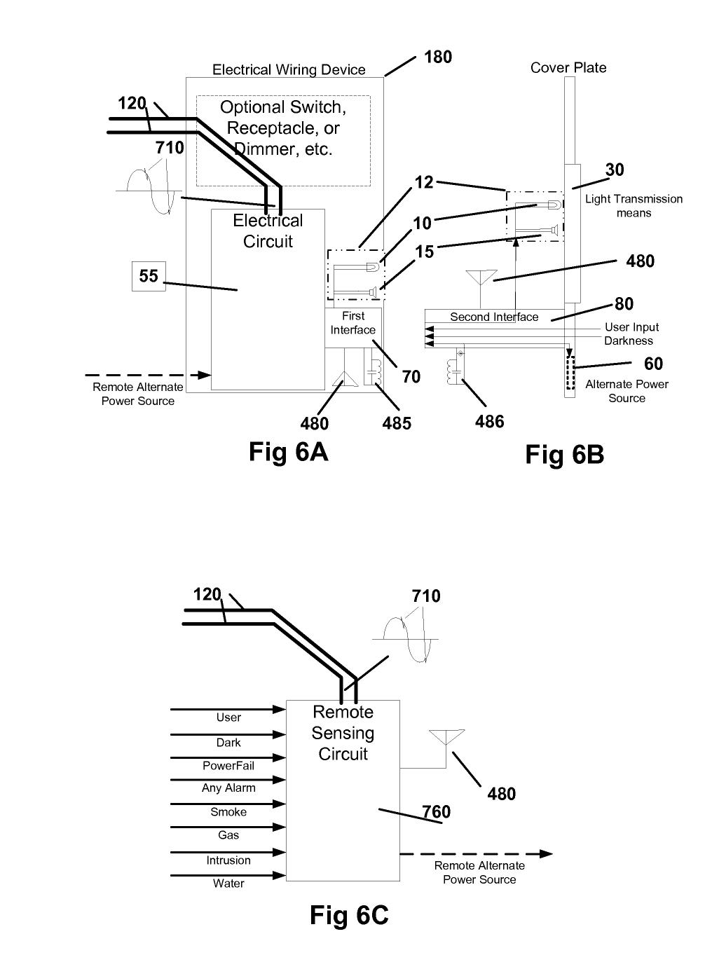

FIG. 6A through FIG. 6C shows a functional block diagram of the Unobtrusive Power Failure Lighting System. FIG. 6A shows the electrical wiring device 180 having a primary power interface 120, an electrical circuit 55, a first interface 70. First interface 70 shows a wireless power transmission means 485 as a component of the first interface 70. A power line control signal 710 is shown as an input to electrical circuit 55. The System safety device 12 is shown as a safety lighting source 10, optional audible alarm source 15 or both. FIG. 6B shows a cover plate having a light transmission means 30, a second interface 80 including wireless power transceiver means 486, and additional modules of the system including user input and darkness sensing inputs to the electrical circuit 55 of the electrical wiring device 180 of FIG. 6A. Of course, it can be seen that the wireless power transmission means 485 and wireless power receiver means 486 may be used to implement the first interface 70 and second interface 80 entirely, including transmission and reception of the needed safety signal function. FIG. 6C shows additional modularity of the system by having a remote electrical circuit 760 with multiple alarm condition inputs providing a signal using power line control signal 710 over primary power interface 120 and optionally supplying alternate power to the electrical wiring device 180 in FIG. 6A.

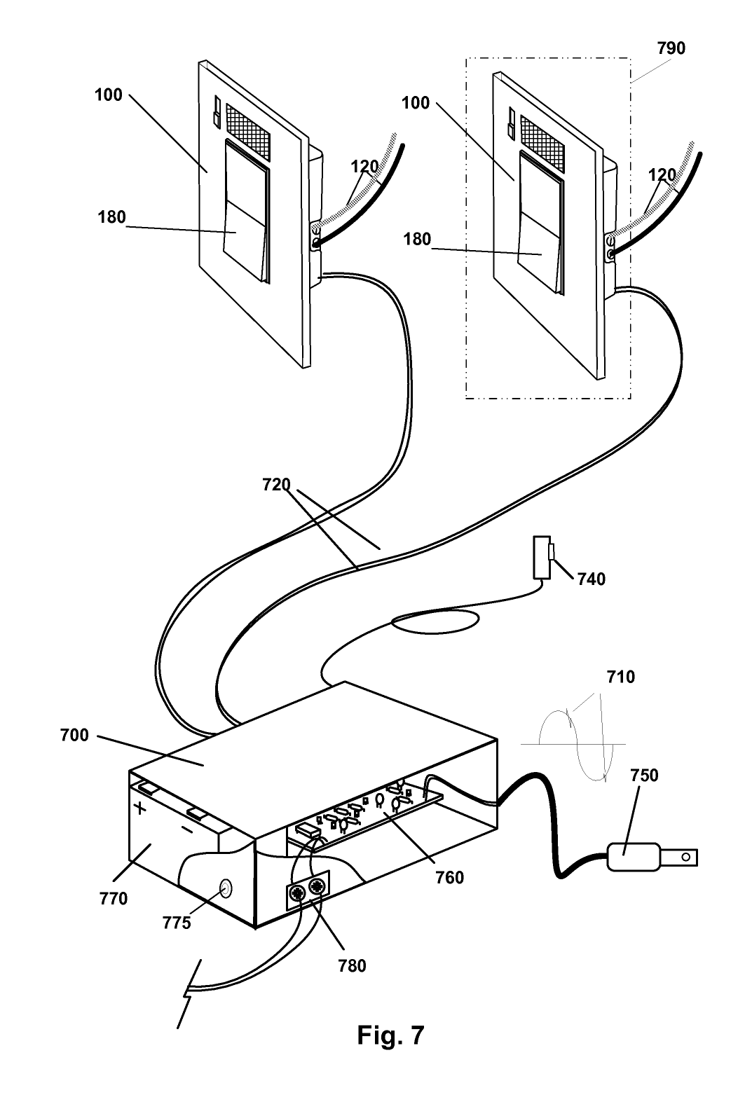

FIG. 7 shows the Unobtrusive Power Failure Lighting System implemented with a remote central system module 700. The remote central system module 700 is connected to primary power through Primary power supply cord 750. Remote light sensor 740 monitors available light while alarm input event interface connector 780 monitors external safety detection systems for alerting conditions. Power Line Control signals 710 are sent over the primary power wiring to the individual concealed safety lighting and alerting device 790 via their primary power interface 120 through primary power supply cord 750. Low voltage wiring 720 may be employed to deliver alternate power during power failures from the remote battery 770 to the individual concealed safety lighting and alerting devices 790. User control of the system is accomplished by pressing remote test button 775. The concealed safety lighting and alerting device is made up of electric wiring device 180 covered by switch cover plate 100.

From the above description it can be seen that the Unobtrusive Power Failure Lighting System provides safety improvements in several ways including general night lighting, power failure lighting, and an alarm condition visual and audible indication. The safety alert audio and lighting control and electrical circuit can be completely integrated into the electrical wiring device. The functions may be distributed as separate modules in electrical communication with each other. The safety lighting and alerting system concealed in electrical wiring devices may be controlled from a remote central system module.

An Unobtrusive Power Failure Lighting System that provides safety lighting and alerting in a concealed or inconspicuous way is described. It is capable of providing night lighting and alarm condition alerts using light and/or sound, and is able to detect the occurrence of a power failure and provide backup safety lighting. The power failure safety lighting mechanism includes an alternate power source which can take the form of, but is not limited to non-rechargeable batteries or rechargeable batteries with sufficient power density to provide a useful lighting period during power failures. The power failure safety light mechanism also includes an ambient light sensor for extending the life of the battery and turning off the nightlight feature during the day, and an optional on-off user control switch for selectively turning the safety light off when not needed. Furthermore, the Unobtrusive Power Failure Lighting System of the present invention is simple and easy to install and use, and is economical to manufacture.

Of course, most power failure lighting solutions have all the elements of the present invention including power failure sensing, an alternate power source, a power failure light source and various controls. The present invention provides a unique structure and combination of these elements to provide an unobtrusive power failure lighting system that offers improvements over prior art and allow improved manufacturability and usability especially for older, smaller wiring devices such as the toggle light switch and classic octagonal/oval style receptacles. This modular approach reduces the size of power failure lighting solutions by allowing functional components to be separated and combined using a specific set of interfaces as described herein.

While certain novel features of this invention have been shown and described using exemplary preferred embodiments, the scope of the invention is not intended to be limited to the details above, since it will be understood that various omissions, modifications, substitutions and changes in the forms and details of the device illustrated and in its operation can be made by those skilled in the art without departing in any way from the spirit of the present invention. The embodiments described herein are for illustrative purposes and may be implemented in a variety of ways dependent on the designer's discretion. Therefore, the scope of the claims should be accorded the broadest interpretation so as to encompass all such modifications and similar arrangements.

1) A system for providing power failure lighting and alerting comprising:
a. An electric wiring device further comprising:
i. A housing having suitable shape and size to fit within a conventional electrical workbox, said housing having a mounting member to affix said housing to said conventional electrical workbox;
ii. A primary power interface for connection to primary power source;
iii. An internal electrical circuit providing at least one signal, said at least one signal including a power failure state signal, said internal electrical circuit in electrical communication with said primary power interface;
iv. A first interface providing a communication path for said at least one signal, said first interface in communication with said internal electric circuit and disposed in such a way as to permit communication with a second interface that is external to said electric wiring device;
b. A cover plate comprising:
i. A housing having sufficient size and shape to cover a rough opening that surrounds said electric wiring device and said conventional electrical workbox;
ii. A mounting means to affix said cover plate over said electrical wiring device;
iii. Said second interface for communicating with said first interface, said second interface disposed in such a way as to permit communication with said first interface;
iv. A safety light source in communication with said second interface through a circuit;
v. A light transmission means to allow light emitted from said safety light source to project away from said cover plate;
Whereby said system provides power failure lighting when said cover plate is installed over said electric wiring device upon receipt of a signal transmitted over said first and second interfaces.

2) The system of claim 1 comprising an electric wiring device and a cover plate, said electric wiring device having a first interface removably connected to said second interface of said cover plate.

3) The electric wiring device of claim 1 having an electric circuit, said electric circuit further comprising an alarm input circuit.

4) The cover plate of claim 1 further comprising an audio alerting device in communication with said second interface, said audio alerting device providing audible sound.

5) The electric wiring device of claim 1 further having an audio alerting device in communication with said electric circuit, said audio alerting device providing audible sound.

6) The cover plate of claim 1 comprising a housing, said housing having suitable structure to accommodate one or more modules, said modules selected from the group of safety lighting source, audio alarm source, light transmission means, user interface control, ambient light sensor, alternate power source, second interface, inductive power transfer receiver, and clear or translucent area.

7) The electrical circuit of claim 1 comprising a user interface input to control the state of said electrical circuit.

8) The electrical circuit of claim 1 comprising a communications interface for receiving and transmitting signals, said communications interface selected from the group of wired, wireless, and power line communications.

9) The communications interface of claim 8 in communication with a remote sensing circuit, said remote sensing circuit having inputs selected from the group of user, darkness, alarm, smoke, gas, intrusion, and water.

10) The electric wiring device of claim 1 comprising a first interface, said first interface selected from the group of wired, wireless, inductive, optical, and mating contacts.

11) The electrical wiring device of claim 1 comprising one or more of the following: switch, receptacle, and dimmer.

12) The cover plate of claim 1 further comprising an ambient light sensor in communication with said circuit.

13) The cover plate of claim 1 further comprising a user interface control providing manual control over one or more features of said system.

14) The electric wiring device of claim 1 comprising a first interface, said first interface providing power to said circuit in said cover plate.

15) The electrical wiring device of claim 1 further comprising an inductive power transmission means to provide power wirelessly to said cover plate.

16) The safety light source of claim 1 having a direct connection to said first interface, said direct connection performing the function of said second interface.

17) A method to emit power failure light from a wall cover plate comprising the steps of:
a. Integrating an electrical circuit internal to an electrical wiring device, said electrical circuit providing a safety signal, said electrical wiring device connected to primary AC power;
b. Affixing a first interface to said electrical wiring device, said first interface communicating said safety signal, said first interface disposed to permit communication with a second interface;
c. Integrating a safety light source with a cover plate, said cover plate revealing at least a portion of said electric wiring device, said cover plate further sealing a rough opening surrounding an installed said electrical wiring device, the state of said safety light source controlled by said safety signal;
d. Mounting said second interface within said cover plate in such a way as to permit communicating with said first interface after installation of said cover plate over said electrical wiring device, said second interface in communication with said safety light source through a cover plate circuit;
e. Providing an alternate power source to be used to supply power to said safety light source when primary power has failed;
f. Arranging a light transmission means to convey light emitted from said safety light source outwardly from said cover plate;
Whereby the installed combination of said electrical wiring device and said cover plate permits said safety light source to emit light into the surrounding area while providing a familiar look and feel of a conventional electric wiring device and cover plate combination;

18) The method of claim 17 wherein the step of integrating an electrical circuit into an electrical wiring device, comprises said electrical wiring device selected from the group of switch, receptacle, dimmer, and blank body.

19) A method to extend the functionality of an electrical wiring device and increase the area needed to employ additional functions and controls without substantially increasing the size of said electrical wiring device comprising the steps of:
a. integrating an electrical circuit internal to said electrical wiring device to provide a power supply, said electrical wiring device suitably equipped to permit connection to primary AC power;
b. Providing an inductive wireless power transmission interface in said electrical wiring device, said inductive wireless power transmission interface connected to said electrical circuit, said inductive wireless power transmission interface further disposed to communicate with an inductive wireless power receiver mounted at a nominal distance from said inductive wireless power transmission interface;
Whereby said inductive wireless power transmission interface provides isolated power for said additional functions that are not integrated into said electric wiring device, thereby relieving the need to substantially increase the size of said electrical wiring device.

20) The method of claim 18 further comprising the step of:
a. Incorporating said inductive wireless power receiver into a cover plate, said inductive wireless power receiver in communication with a cover plate circuit said cover plate circuit comprising at least one load;
b. Mounting said cover plate proximal to said electrical wiring device such that power transmission occurs from said power supply in said electrical wiring device to said inductive wireless power receiver in said cover plate.
